(19) United States
(12) Patent Application Publication
(10) Pub. No.: US 2011/0034318 A1
(43) Pub. Date: Feb. 10, 2011

(54) PROCESS AND PLANT FOR THE HEAT TREATMENT OF FINE-GRAINED MINERAL SOLIDS

(75) Inventors: Edgar Gasafi, Karlsruhe (DE); Guenter Schneider, Lorsch (DE); Michael Missalla, Oberursel (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: OUTOTEC OYJ, Espoo (FI)

(21) Appl. No.: 12/936,403

(22) PCT Filed: Apr. 20, 2009
(86) PCT No.: PCT/EP09/02860

§ 371 Date: Oct. 5, 2010

(30) Foreign Application Priority Data
Apr. 24, 2008 (DE) 10 2008 020 600.8

(51) Int. Cl. F27B 15/00; C04B 33/00; C01F 11/46; B01J 8/00

(52) U.S. Cl. 501/150; 423/555; 422/622; 422/139

(57) ABSTRACT

A process for heat treatment of fine-grained mineral solids includes passing fine-grained mineral solids through a flash reactor so as to contact the fine-grained mineral solids with hot gases in the flash reactor at a temperature of 450 to 1500° C. so as to obtain hot solids. The hot solids arc passed through a residence time reactor at a temperature of 500 to 890° C. The hot solids are withdrawn from the residence time reactor after a residence time of 1 to 600 minutes. A waste gas of the residence time reactor is recirculated to at least one of the flash reactor and a preheating stage.

### CROSS REFERENCE TO PRIOR APPLICATIONS

This application is a U.S. National Phase application under 35 U.S.C. §371 of International Application No. PCT/EP2009/002860, filed on Apr. 20, 2009 and which claims benefit to German Patent Application No. 10 2008 020 600.8, filed on Apr. 24, 2008. The International Application was published in English on Oct. 29, 2009 as WO 2009/129977 A1 under PCT Article 21(2).

### FIELD

The present invention relates to a process for the heat treatment of fine-grained mineral solids to calcine, for example, clay or clay-like substances or gypsum, and to a plant for performing this process.

### BACKGROUND

Calcining fine-grained mineral solids, such as clay, is conventionally effected in rotary kilns or multiple-hearth furnaces. This provides the maintenance of a low temperature with a residence time necessary for the treatment in this process. U.S. Pat. No. 4,948,362, for instance, describes a process for calcining clay in which kaolin clay is treated in a multiple-hearth calcining furnace by means of a hot calcining gas to increase gloss and minimize abrasiveness. In an electrostatic precipitator, the calcined clay powder is separated from the waste gas of the calcining furnace and processed to obtain the desired product.

Processes are known which allow the avoidance of movable plant equipment, such as a rotary kiln or rotating scrapers in multiple-hearth furnaces, and to reduce the residence time. These include flash reactors and fluidized-bed technologies.

U.S. Pat. No. 6,168,424 describes a plant for the heat treatment of suspended mineral solids, such as clay, in which the solids are supplied to a flash reactor upon preheating in a plurality of preheating stages. In the flash reactor, the solids are calcined in a heat treatment conduit by means of hot gases, which are generated in a combustion chamber. The calcined product is then cooled to the desired product temperature in a plurality of cooling stages.

The paper “Properties of Flash-Calcined Kaolinite” in “Clays and Clay Minerals”, Vol. 33, No. 3, 258-260, 1985, D. Bridson, T. W. Davies and D. P. Harrison also describes the use of flash calcination for the treatment of kaolin. In this process, the solids are heated very quickly, maintained at the temperature for a short period, and then quickly cooled again. The kaolin is flash-calcined for 0.2 to 2 seconds at temperatures between 900 and 1250° C. It was recognized, however, that despite a sufficient high temperature, that only a partial dehydroxylation is effected since this short treatment time is not sufficient to achieve an equilibrium.

In flash reactors, the residence time is very short, which is compensated by an elevated treatment temperature in the reactor. In the case of temperature-sensitive substances, such as clay or gypsum, maximum temperatures should be observed, the risk of the material being sintered exists when the maximum temperatures are exceeded. Moreover, clay in particular involves the risk that the pozzolanic reactivity gets lost at excessive temperatures. Pozzolans are silicatic and alumosilicatic substances which react hydraulically with calcium hydroxide (lime hydrate) and water to form calcium silicate hydrates and calcium aluminahydrates. These crystals also are obtained as a result of the hardening (hydration) of cement and lead to, for example, to the strength and structural density of concrete. For kaolinitic clay, a temperature of 800° C. therefore should therefore not be permanently exceeded. At such temperatures, the desired material properties can, however, not be achieved due to the short residence time in the flash reactor.

DE 102 60 741 A1 describes a process for the heat treatment of gypsum in which the solids are heated to a temperature of about 750° C. in an annular fluidized-bed reactor with a recirculation cyclone and calcined to anhydrite. By means of the annular fluidized bed, a sufficiently long solids residence time is achieved and a good mass and heat transfer.

DE 25 24 540 C2 describes a process for calcining filter-moist aluminum hydroxide in which the aluminum hydroxide is charged to a fluidized-bed reactor supplied with fluidizing air, in which a temperature of 1100° C. is obtained by two-stage combustion, and calcined. Upon separation of the gas, the solids discharged from the fluidized-bed reactor are supplied to a residence time reactor in which the solids in turn are maintained in a slight turbulent movement at a temperature of 1100° C. by adding gas with a low velocity. A partial stream of the solids is recirculated to the fluidized-bed reactor via a conduit. The residence time in the reactor system is divided between fluidized-bed reactor and residence time reactor in a ratio of 1:3.3.

### SUMMARY

An aspect of the present invention is to provide an energy-efficient configuration to provide desired particle properties, for example, when calcining clay or clay-like substances or gypsum.

In an embodiment, the present invention provides a process for heat treatment of fine-grained mineral solids which includes passing fine-grained mineral solids through a flash reactor so as to contact the fine-grained mineral solids with hot gases in the flash reactor at a temperature of 450 to 1500° C. so as to obtain hot solids. The hot solids are passed through a residence time reactor at a temperature of 500 to 890° C. The hot solids are withdrawn from the residence time reactor after a residence time of 1 to 600 minutes. A waste gas of the residence time reactor is recirculated to at least one of the flash reactor and a preheating stage.

### BRIEF DESCRIPTION OF THE DRAWINGS

The present invention is described in greater detail below on the basis of embodiments and of the drawings in which:

FIG. 1 shows a basic flow diagram of the process of the present invention;

FIG. 2 shows an embodiment of the process for calcining clay; and

FIG. 3 shows an embodiment of the process for calcining gypsum.

In an embodiment of the present invention, the solids are passed through a flash reactor, in which they are contacted with hot gases at a temperature of 450 to 1500° C., for example, 500 to 890° C., and subsequently are passed through a residence time reactor at a temperature of 500 to 890° C., from which they are withdrawn after a residence time of 1 to 600 minutes, for example, between 1 and 60 minutes, when using a reactor with stationary fluidized bed, and between 10 and 600 minutes when the same is configured as rotary kiln, and possibly are supplied to a further treatment stage.

The flash reactor provides for a fast performance of the first treatment step. Due to thorough mixing of the particles, the heat and mass transfer is substantially improved, so that chemical reactions proceed much faster than in a revolving-tube or multiple-hearth calcining furnace. Subsequently, a sufficient residence time is provided by the residence time reactor so that the desired material properties are provided by observing the specified maximum temperature. This provides a more economic design of the process and of the plant used therefore.

Due to the thorough mixing in the flash reactor, it is possible to briefly expose the material to be calcined to a temperature distinctly higher than the usually admissible calcining temperature. The temperature of the hot gas can lie more than 200° C. above the average temperature in the flash reactor. This is possible because the contact with the hot gas only is very short and a fast dissipation of heat is possible. Hence, there is no negative change of material.

In an embodiment of the present invention, the residence time of the solids in the flash reactor is between 0.5 and 20 seconds, for example, between one and ten seconds, or between two and eight seconds. The gas velocities and hence the residence times of the solids can be determined based on the treated materials and the desired material properties as well as the configuration of the flash reactor. Even with a minimum residence time in the residence time reactor of only one minute, there is obtained a very short treatment time in the flash reactor as compared to the residence time reactor of, for example, smaller than 1:6 or smaller than 1:7.5. With a longer residence time in the residence time reactor, this ratio is correspondingly reduced down to 1:1200.

When calcining clay or clay-like substances, the temperature in the flash reactor in accordance with the present invention can, for example, be about 550 to 850° C., or 600 to 750° C., or between 650 and 700° C.

The temperature in the flash reactor can be achieved both by an external combustion, such as in an upstream combustion chamber, and by an internal combustion in the flash reactor. Hot waste gases from other process steps or other plants can also be used. Internal combustion can, for example, occur at higher process temperatures above 700° C.

In an embodiment of the present invention, it is possible to charge the flash reactor with cold or hot pyrolysis and/or gasification products or products from substoichiometric combustions (for example CO-containing gases) and perform a further combustion in the flash reactor. There can, however, also be used special fuels with a low burning temperature, such as propane.

The internal combustion in the flash reactor can, for example, be controlled by the residence time, the size of the flash reactor or the construction, for example, as a tube or as a cyclone. A complete internal combustion can be provided, but it is also possible to provide an afterburning chamber after the flash reactor in order to provide a complete combustion of the fuel.

When calcining gypsum, the temperature in the flash reactor can, for example, be about 540 to 880° C., but when supplying hot gases it can, for example, be about 650 to 850° C. or between 700 and 750° C., in the case of an internal combustion, for example, between 740 and 850° C., such as about 750 to 800° C.

In an embodiment of the present invention, the heat treatment in the residence time reactor is effected by means of hot gases, wherein the residence time of the gases in the residence time reactor can, for example, be between 0.1 and 10 seconds. In this way, the temperature in the residence time reactor can be adjusted accurately. In a residence time reactor which constitutes a rotary kiln, the residence time of the solids can, for example, be 20 to 300 min, and in a reactor formed as fluidized bed it can, for example, be 1 to 30 min.

In the calcination of clay or clay-like substances in accordance with the present invention, the temperature in the residence time reactor can, for example, be about 550 to 850° C., such as about 600 to 750° C., or about 650 to 700° C., whereby an impairment of the pozzolanic reactivity is reliably prevented.

In the case of the heat treatment of gypsum, however, the temperature in the residence time reactor in accordance with the present invention is slightly higher, namely about 540 to 880° C., for example, about 550 to 850° C., or about 700 to 800° C. At the higher process temperatures, however, an internal combustion is likewise possible.

Delivery in the flash reactor, which in a wider sense is an entrained-bed reactor, is effected by a gas stream which entrains the solids. A hot gas stream can, for example, be supplied. In accordance with an embodiment of the present invention, the Particle-Froude-Number in the flash reactor can, for example, lie between 40 and 300, such as between 60 and 200, whereby it is provided that the solid particles pass through quickly and hence with corresponding short residence times. The Particle-Froude-Numbers each are defined by the following equation:

$${Fr}_{P} = \frac{u}{\sqrt{\frac{( {ρ}_{s} - {ρ}_{f} )}{{ρ}_{f}} * {d}_{p} * g}}$$

wherein

u=effective velocity of the gas flow in m/s;

ρₛ=density of a solid particle in kg/m³;

ρ_{f}=effective density of the fluidizing gas in kg/m³;

dₚ=mean diameter in m of the particles of the reactor inventory (or of the particles formed) during operation of the reactor; and

g=gravitational constant in m/s².

When using this equation, it should be considered that dₚ does not designate the grain size (d₅₀) of the material supplied to the reactor, but the mean diameter of the reactor inventory formed during operation of the reactor, which can differ significantly in both directions from the mean diameter of the material used (primary particles). From very fine-grained material with a mean diameter of 3 to 10 μm, particles (secondary particles) with a grain size of 20 to 30 μm are formed, for instance, before introduction into the plant or the flash reactor or during the heat treatment. On the other hand, some materials or secondary particles formed are disintegrated during the heat treatment or as a result of the mechanical load in the gas flow.

In an embodiment of the present invention, the efficiency of the process is increased in that the solids are preheated before introduction into the flash reactor. For preheating, waste gases from the flash reactor can, for example, be used completely or in part. During preheating, dusts usually are obtained, which can directly be supplied to the flash reactor or the residence time reactor.

In an embodiment of the present invention, the waste gas of the residence time reactor is recirculated to the flash reactor in order to increase the yield of the process. The dust-laden waste gas first can roughly be cleaned, for example, by means of a cyclone, and the dust separated can be supplied to the cooling means. For an optimum utilization of the heat contained in the waste gas, recirculation to a preheating stage can be effected in accordance with the present invention.

The hot solids from the residence time reactor can subsequently be cooled directly or indirectly, and the heat can, for example, be used for heating the combustion gas for the flash reactor or the upstream combustion chamber. The heat produced in a possibly present afterburning chamber can also be used in the process, for example, for preheating the gas or the solids.

The present invention also provides a plant for the heat treatment of fine-grained mineral solids, for example, to calcine clay and gypsum, which is suitable for performing the process described above. In accordance with the present invention, the plant comprises a flash reactor, through which the solids are passed at a temperature of 450 to 1500° C., for example, 500 to 890° C., and a residence time reactor, through which the solids are subsequently passed at a temperature of 500 to 890° C.

In an embodiment of the present invention, the residence time reactor can be a rotary kiln. In accordance with an embodiment of the present invention, the residence time reactor includes a gas-solids suspension, for example, a stationary fluidized bed, or a conveying section.

In an embodiment of the present invention, a cooling system can be arranged behind the residence time reactor, comprising direct and/or indirect cooling stages, for example, cooling cyclones and/or fluidized-bed coolers. In a direct cooling stage, the cooling medium directly gets in contact with the product to be cooled. Even during the cooling process, desired reactions such as product refinements still can be performed. In addition, the cooling effect of direct cooling stages is particularly good. In indirect cooling stages, cooling is effected by means of a cooling medium flowing through a cooling coil.

For adjusting the necessary process temperatures in the flash reactor, a combustion chamber with supply conduits for fuel, oxygen and/or heated gas, such as air, can be provided upstream of the same, whose waste gas is introduced into the flash reactor as hot conveying gas. The combustion chamber can, however, also be omitted, when the reactor temperature can be chosen high enough for an ignition and stable combustion (internal combustion in the flash reactor).

In an embodiment of the present invention, at least one preheating stage for preheating the solids can be provided before the flash reactor.

In an embodiment of the present invention, a separator, such as a cyclone separator, can be provided downstream of the reactor to separate the solid particles from the gas stream.

Further features, advantages and possible applications of the present invention can also be taken from the following description of embodiments and the drawing. All features described and/or illustrated form the subject-matter of the present invention per se or in any combination, independent of their inclusion in the claims or their back-reference.

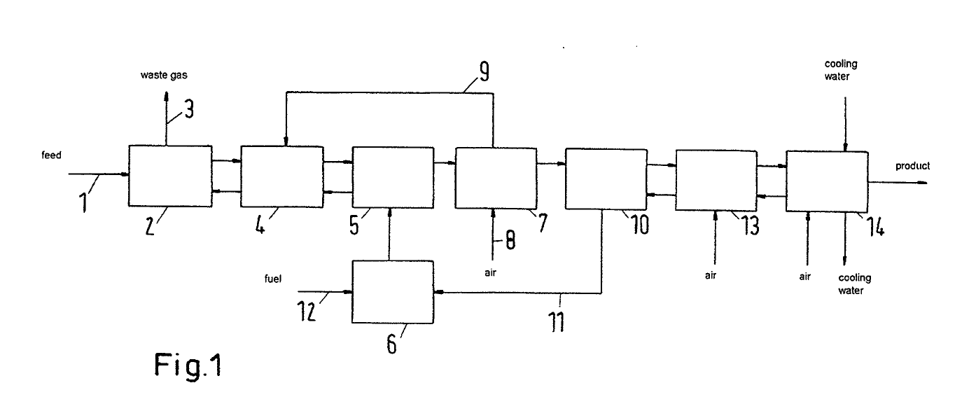

FIG. 1 schematically shows a plant for performing the process of the present invention.

Via a supply conduit 1, the solids to be treated, such as clay or gypsum, are supplied to a preheating stage 2 and heated to a temperature of about 300° C. Via a waste gas conduit, the waste gas is supplied to a non-illustrated dust separator or other parts of the plant. The solids then are heated to a temperature of 300 to 500° C. in a second preheating stage 4, before they are supplied to a flash reactor 5. In the flash reactor 5, which for instance is an entrained-bed reactor with a height of about 30 m, the solids are calcined with hot gases, which are generated in a combustion chamber 6, at a temperature of 600 to 850° C., in particular 650 to 700° C. (clay) or 700 to 750° C. (gypsum). Into the flash reactor 5, such a volume flow of hot gases is introduced that a Particle-Froude-Number of 40 to 300, for example, about 60 to 200, is obtained and the solids are quickly conveyed through the flash reactor 5. In an embodiment of the present invention, a residence time of, for example, two to eight seconds is provided. Depending on the material and the desired heat treatment, the residence time of the solids in the flash reactor can, however, also lie between 0.5 and 20 seconds.

The solids discharged from the flash reactor 5 together with the hot conveying gas are separated from the conveying gas in a non-illustrated separator, in particular a cyclone, and supplied to a residence time reactor 7 configured as rotary kiln or stationary fluidized bed, in which the solids are subjected to a heat treatment depending on their composition (result of the flash calcination) and the desired product properties for 1 to 600 minutes, for example, for 1 to 30 minutes when the residence time reactor 7 includes a stationary fluidized bed, and for 10 to 600 minutes when the residence time reactor 7 is configured as a rotary kiln.

In an embodiment of the present invention, the temperature in the residence time reactor 7 can, for example, be about 550 to 850° C., and for the calcination of clay, for example, about 650 to 700° C., whereas for the calcination of gypsum it can, for example, be about 700 to 750° C. The temperature in the residence time reactor 7 is controlled by the supply air, which is supplied via a conduit 8. The residence time of the gases in the residence time reactor 7 is between 1 and 10 seconds, so that the temperature can accurately be adjusted and adapted to the desired product properties. In addition, fuel can be supplied to the residence time reactor 7 for an internal combustion. The dust-laden waste gas from the residence time reactor 7 is recirculated to the second preheating stage 4 via a return conduit 9. In the process, the dust-laden waste gas also can roughly be dedusted.

The solids are withdrawn from the residence time reactor 7 and supplied to a first cooling stage 10, in which the product is cooled in one or more stages in counterflow with the combustion air, wherein a direct or indirect cooling can be performed. Via conduit 11, the air heated in this way is supplied as combustion air to the combustion chamber 6, in which fuel supplied via a fuel conduit 12 is burnt and thereby heats the combustion air, which subsequently is supplied to the flash reactor 5. Part of the preheated air can also be used for fluidizing the residence time reactor.

Subsequently, the product can further be cooled with air in a second cooling stage 13 and then be supplied to a fluidized-bed cooler 14, in which the solids are cooled with air and/or cooling water to the desired product temperature, for example, about 50 to 60° C.

### Example 1

### Calcination of Clay

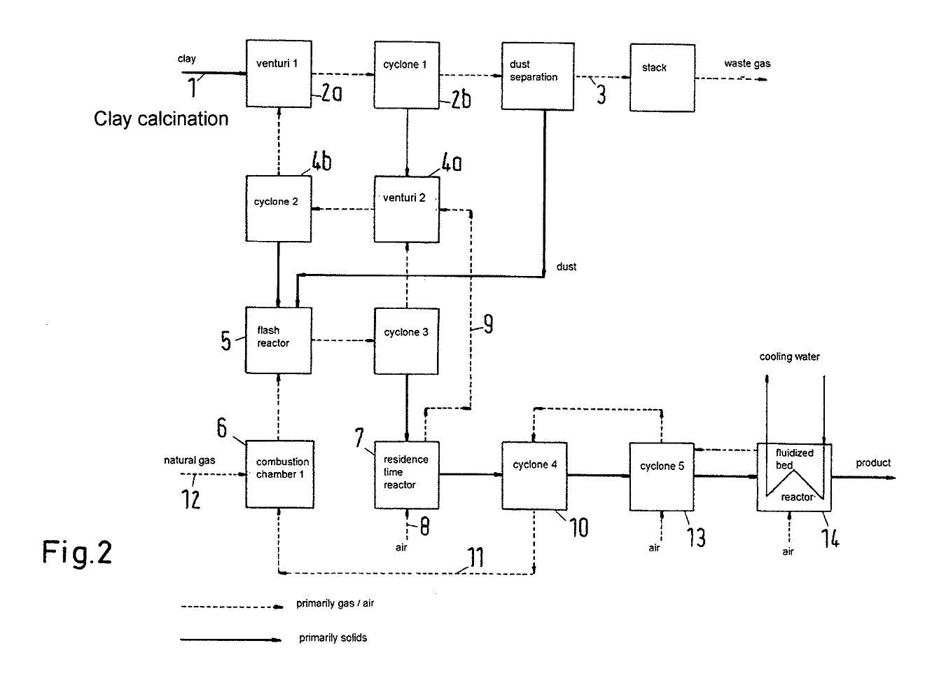

A plant for producing 1300 t of calcined clay per day, which is schematically shown in FIG. 2, is operated with natural gas which has a net calorific value (NCV) of 50000 kJ/kg.

With a moisture content of 7%, the clay-like starting material rich in kaolin is preheated to a temperature of 500° C. in two successive preheating stages, which consist of Venturi preheaters 2a, 4a and cyclone separators 2b, 4b, and charged to the flash reactor 5. The same is operated at 650 to 700° C. and with a residence time of 5 seconds. The residence time reactor 7 is configured as a stationary fluidized-bed reactor and operated at 630 to 680° C. There is desired a Particle-Froude-Number of 3, which in operation lies in the range from 2 to 4 due to the variation of particle size. The residence time is 13 to 22 min, for example, 16 to 20 min.

The hot gas for adjusting the necessary process temperature in the flash reactor 5 is generated in a combustion chamber 6. For providing 77000 Nm³/h of hot gas at a temperature of 1000° C., 1600 kg/h of natural gas are required. The combustion air is preheated to a temperature of 340° C. by cooling the product leaving the residence time reactor 7 with a temperature of 650° C. and supplied to the combustion in the combustion chamber 6. In the process, the product is cooled from 650° C. to about 150° C. and finally is cooled to the desired final temperature of 55° C. in a fluidized bed cooler 14.

### Example 2

### Calcination of Gypsum

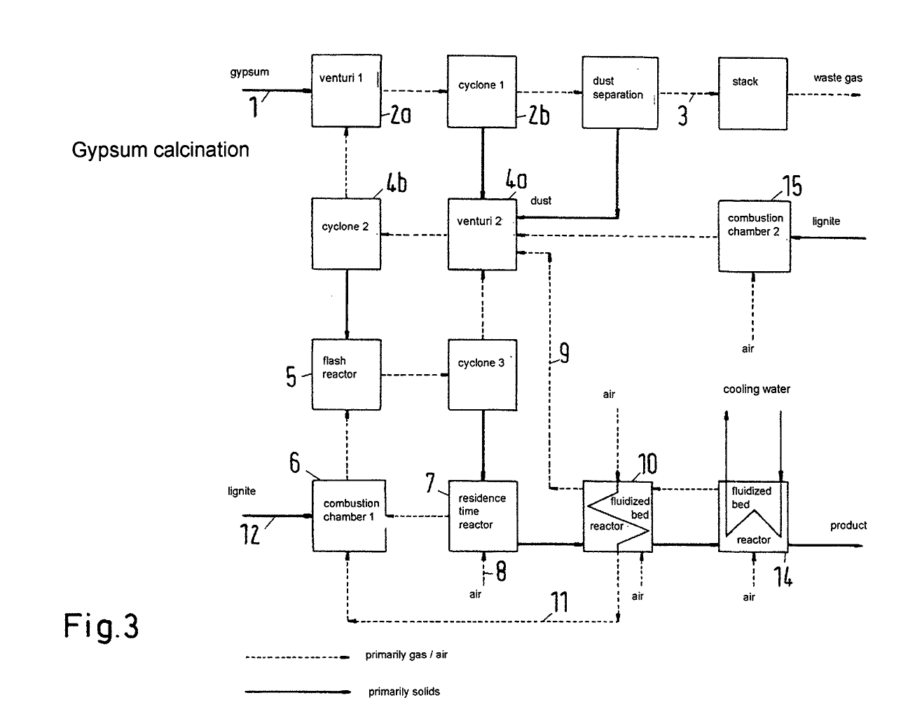

A plant for producing 700 t of calcined gypsum per day, which is schematically shown in FIG. 3, is operated with lignite which has a net calorific value (NCV) of 22100 kJ/kg.

With a moisture content of 8%, the starting material is preheated to a temperature of 320° C. in two successive preheating stages, which consist of Venturi preheaters 2a, 4a and cyclone separators 2b, 4b, and precalcined; additional heat is supplied to the Venturi 4a by supplying a hot gas of 1050° C. to the Venturi 4a, which is generated in a combustion chamber 15 with 0.5 t/h of lignite and 7500 Nm³/h of air. The preheated and precalcined solids are charged to the flash reactor 5. The same is operated at 700 to 750° C. and with a residence time of 10 seconds. The residence time reactor 7 is configured as a stationary fluidized-bed reactor and operated at 700° C. There is desired a Particle-Froude-Number of 3, which in operation lies in the range from 2 to 4 due to the variation of particle size. The residence time is 15 to 25 min, for example, 18 to 22 min.

The hot gas for adjusting the necessary process temperature in the flash reactor 5 is generated in a combustion chamber 6. For generating 27000 Nm³/h of hot gas at a temperature of 1050° C., 1.5 t/h of lignite are required. The required combustion air of 26300 Nm³/h is preheated to a temperature of 250° C. by cooling the product leaving the residence time reactor 7 with a temperature of 700° C. and supplied to the combustion in the combustion chamber 6. In the process, the product is cooled from 700° C. to about 250° C. and finally is cooled with cooling water to the desired final temperature of 60° C. in a fluidized bed cooler 14.

The present invention is not limited to embodiments described herein; reference should be had to the appended claims.

### LIST OF REFERENCE NUMERALS

1 supply conduit

2 first preheating stage

2a Venturi preheater

2b cyclone separator

3 waste gas conduit

4 second preheating stage

4a Venturi preheater

4b cyclone separator

5 flash reactor

6 combustion chamber

7 residence time reactor

8 air conduit

9 return conduit

10 first cooling stage

11 combustion air conduit

12 fuel conduit

13 second cooling stage

14 fluidized-bed cooler

15 combustion chamber

1-21. (canceled)

22. A process for heat treatment of fine-grained mineral solids, the process comprising:
passing fine-grained mineral solids through a flash reactor so as to contact the fine-grained mineral solids with hot gases in the flash reactor at a temperature of 450 to 1500° C. so as to obtain hot solids;
passing the hot solids through a residence time reactor at a temperature of 500 to 890° C., the hot solids being withdrawn from the residence time reactor after a residence time of 1 to 600 minutes; and
recirculating a waste gas of the residence time reactor to at least one of the flash reactor and a preheating stage.

23. The process as recited in claim 22, further comprising supplying to a further treatment stage the hot solids withdrawn from the residence time reactor.

24. The process as recited in claim 22, wherein the hot solids have a residence time in the flash reactor of between 0.5 and 20 seconds.

25. The process as recited in claim 22, wherein the residence time reactor includes a stationary fluidized bed and the residence time of the hot solids in the residence time reactor is 1 to 60 minutes.

26. The process as recited in claim 22, wherein the residence time reactor includes a rotary kiln and the residence time of the hot solids in the residence time reactor is 10 to 600 minutes.

27. The process as recited in claim 22, wherein the flash reactor temperature is about 550 to 850° C., the fine-grained mineral solid is clay, and the heat treatment includes a calcining of the clay.

28. The process as recited in claim 22, wherein the flash reactor temperature is about 540 to 880° C., the fine-grained mineral solid is gypsum, and the heat treatment includes a calcining of the gypsum.

29. The process as recited in claim 22, further comprising heating gases in the flash reactor by internal combustion.

30. The process as recited in claim 22, further comprising heat treating the hot solids in the residence time reactor with hot gases, wherein a residence time of the hot gases in the residence time reactor is between 0.1 and 10 seconds.

31. The process as recited in claim 22, wherein a temperature in the residence time reactor is about 550 to 850° C., the fine-grained mineral solid is clay, and the heat treatment includes a calcining of the clay.

32. The process as recited in claim 22, wherein a temperature in the residence time reactor is about 540 to 880° C., the fine-grained mineral solid is gypsum, and the heat treatment includes a calcining of the gypsum.

33. The process as recited in claim 22, wherein a Particle-Froude-Number in the flash reactor is between 40 and 300.

34. The process as recited in claim 22, further comprising preheating the fine-grained mineral solids before the passing the fine-grained mineral solids through the flash reactor.

35. A plant for the heat treatment of fine-grained mineral solids, the plant comprising:
a flash reactor configured to have the fine-grained mineral solids passed therethrough at a temperature of 450 to 1500° C. so as to obtain hot solids; and
a residence time reactor configured to have the hot solids passed therethrough at a temperature of 500 to 890° C.; and
a return conduit configured to recirculate a waste gas of the residence time reactor to at least one of the flash reactor and a preheating stage.

36. The plant as recited in claim 35, wherein the residence time reactor is a rotary kiln.

37. The plant as recited in claim 35, wherein the residence time reactor includes a stationary fluidized bed.

38. The plant as recited in claim 35, further comprising a cooling system disposed downstream of the residence time reactor, the cooling system including at least one of a direct and an indirect cooling stage.

39. The plant as recited in claim 35, further comprising a combustion chamber configured to generate a hot gas and disposed upstream of the flash reactor.

40. The plant as recited in claim 35, wherein the preheating stage is configured to preheat the fine-grained mineral solids and is disposed upstream of the flash reactor.

41. The plant as recited in claim 35, further comprising a separator disposed downstream of the flash reactor.

42. The plant as recited in claim 35, wherein the fine-grained mineral solids include at least on of clay and gypsum and the heat treatment includes a calcining of the at least one of clay and gypsum.
